(19) United States
(12) Patent Application Publication
(10) Pub. No.: US 2004/0138977 A1
(43) Pub. Date: Jul. 15, 2004

(54) Asset monetization

(76) Inventors: Richard M. Tomkins, Glencoe, IL (US); D. Michael Tomkins, Seattle, WA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/339,093

(22) Filed: Jan. 9, 2003

(51) Int. Cl. G06F 17/60

(52) U.S. Cl. 705/36

(57) ABSTRACT

Methods, systems, and articles of manufacture for monetizing an asset having a long-term value. At least a portion of the long-term value of the asset is accounted for as capital on a capital account of a financial institution for a period of time. An income is distributed to an owner of the asset during the period of time responsive to the accounting for the long-term value of the asset as capital on the capital account, wherein the owner of the asset maintains ownership of the asset during the period of time.

### FIELD OF THE INVENTION

The present invention relates to financial transactions, and in particular, relates to methods for generating capital and income.

### BACKGROUND OF THE INVENTION

Even with the advent and elaboration of cash economies over several millennia, holders of assets with long-term values have conventionally had limited and unattractive ways to convert the long-term value of their assets into cash useable in the general cash-based economies in which they participate.

An asset holder's access to current and near-term income (sometimes summarized herein as “near-term” income) based on ownership and use of an asset has conventionally been restricted. The asset holder conventionally realizes revenues or income by extracting or otherwise exploiting a portion of the asset and selling that portion of the asset in the normal course of business. These conventional business processes, however, often generate insufficient cash income for the asset holder's purposes.

Therefore, the asset holder typically considers selling some or all of the short-term or long-term values of the asset, or obtaining loans against the asset requiring the asset holder to cede valuable rights, interests, and possibly actual ownership of the asset in question. For example, public figures such as entertainers and sports personalities can obtain financing of their anticipated earnings through Bowie bonds. The Bowie bond is a loan or advance to the public figure that must be repaid to the Bowie bondholder from the public figure's anticipated earnings.

The asset holder therefore is faced with an unattractive choice: satisfy short-term cash requirements at the expense of potentially losing ownership or control over the asset, or fail to obtain required cash at the cost of making uneconomic decisions regarding use of its asset and still possibly eventually losing ownership or control of the asset.

Further, a financial institution, such as a bank or insurance company, may desire to increase the capital held in its capital accounts. For example, applicable banking laws and rules may limit a bank from making total loans in excess of certain multiples of its capital accounts. Likewise, applicable insurance laws and rules may limit an insurance company from issuing insurance policies representing total risks and total premiums in excess of certain multiples of its capital accounts. In these and other cases, if the capitalizing financial institution's capacity to undertake its normal business activities is limited due to restrictions stemming from its current capital accounts, it may seek to enter into the capital markets to increase its capital.

Typically, financial institutions obtain additional capital through, for example, the conventional equity and debt markets. These markets, however, may provide capital to the capitalizing financial institution at a pace slower than the rate at which the financial institution otherwise wants to raise capital. Further, transactions conducted through the conventional markets are typically associated with high transaction costs. The capitalizing financial institution may also find the conventional markets inadequately responsive to its appeals for additional capital, and may price the capital sought by the financial institution unfavorably in relation to the market prices for capital of enterprises in other sectors of the economy

### SUMMARY OF THE INVENTION

Methods, systems, and articles of manufacture consistent with the present invention enable an asset holder to convert the long-term value of an asset into near-term income, such as cash. The asset holder receives such near-term income from a financial institution in exchange for allowing the financial institution to use the asset's long-term value as a capital asset of the financial institution. In the process, the asset holder does not relinquish ownership or possession of the asset. For purposes of this disclosure, this process is referred to herein as “asset monetization”.

To monetize the asset, the asset holder seeks to enter a monetizing transaction with the financial institution. Under the monetizing transaction, the asset holder allows the financial institution to account for the asset or its value (or portion of the asset or its value) on the financial institution's capital accounts for a period of time. This enables the financial institution, for example, to leverage its increased capital to issue additional loans or insurance policies. In return, the financial institution pays the asset holder at least one negotiated payment for allowing the financial institution to use the value of the asset in accounting for its capital. At the end of the stipulated period of time, the financial institution removes the capital from its capital accounts.

In accordance with methods consistent with the present invention, a method for monetizing an asset having a long-term value is provided. In an embodiment, the method comprises the steps of: accounting for at least a portion of the long-term value of the asset as capital on a capital account of a financial institution for a period of time; and distributing an income to an owner of the asset during the period of time responsive to the accounting for the long-term value of the asset as capital on the capital account, wherein the owner of the asset maintains ownership of the asset during the period of time.

In accordance with methods consistent with the present invention, a method in a data processing system having a program is provided. In an embodiment, the method comprises the steps performed by the program of: accounting for at least a portion of a long-term value of an asset as capital on a capital account of a financial institution for a period of time; and distributing an income to an owner of the asset during the period of time responsive to the accounting for the long-term value of the asset as capital on the capital account, wherein the owner of the asset maintains ownership of the asset during the period of time.

In accordance with articles of manufacture consistent with the present invention, a computer-readable medium containing instructions that cause a program, in a data processing system, to perform a method is provided. In an embodiment, the method comprises the steps of: accounting for at least a portion of the long-term value of the asset as capital on a capital account of a financial institution for a period of time; and distributing an income to an owner of the asset during the period of time responsive to the accounting for the long-term value of the asset as capital on the capital account, wherein the owner of the asset maintains ownership of the asset during the period of time.

In accordance with systems consistent with the present invention, a data processing system is provided. In an embodiment, the data processing system comprises: a memory comprising a program that accounts for at least a portion of a long-term value of an asset as capital on a capital account of a financial institution for a period of time, and distributes an income to an owner of the asset during the period of time responsive to the accounting for the long-term value of the asset as capital on the capital account, wherein the owner of the asset maintains ownership of the asset during the period of time; and a processing unit that runs the program.

In accordance with systems consistent with the present invention, a data processing system is provided. In an embodiment, the data processing system comprises: means for accounting for at least a portion of the long-term value of the asset as capital on a capital account of a financial institution for a period of time; and means for distributing an income to an owner of the asset during the period of time responsive to the accounting for the long-term value of the asset as capital on the capital account, wherein the owner of the asset maintains ownership of the asset during the period of time.

Other methods, systems, features, and advantages of the invention will become apparent to one having skill in the art upon examination of the following figures and detailed description. It is intended that all such additional, methods, systems, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention.

FIG. 1 depicts a block diagram of a system for asset monetization.

FIG. 2 depicts a flow diagram illustrating exemplary steps for conducting the monetizing transaction of FIG. 1 initiated by the asset holder.

FIG. 3 depicts a flow diagram illustrating the exemplary steps for conducting the monetizing transaction of FIG. 1 initiated by a capitalizing financial institution.

FIG. 4 depicts a block diagram of the system for asset monetization of FIG. 1 including an intermediate financial institution.

FIG. 5 depicts a flow diagram illustrating exemplary steps for conducting the monetizing transaction of FIG. 4.

FIG. 6 depicts a block diagram of the system for asset monetization of FIG. 1 including a purchasing party.

FIG. 7 depicts a flow diagram illustrating exemplary steps for conducting the monetizing transaction of FIG. 6.

FIG. 8 depicts a block diagram of the system for asset monetization of FIG. 1 including an intermediate financial institution and an intermediary entity.

FIG. 9 depicts a flow diagram illustrating exemplary steps for conducting the monetizing transaction of FIG. 8.

FIG. 10 depicts a block diagram of the system for asset monetization of FIG. 1 including multiple asset holders, intermediaries, and capitalizing financial institutions.

FIG. 11 depicts a flow diagram illustrating exemplary steps for conducting the monetizing transaction of FIG. 10.

FIG. 12 depicts a block diagram of a data processing system suitable for use with methods and systems consistent with the present invention.

FIG. 13 depicts a block diagram of a computer system suitable for use with methods and systems consistent with the present invention.

FIG. 14 depicts a block diagram of a client-server based data processing system suitable for use with methods and systems consistent with the present invention.

FIG. 15 depicts a flow diagram illustrating exemplary steps performed by an asset monetization program.

### DETAILED DESCRIPTION OF THE PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention enable an asset holder to convert the long-term value of an asset into near-term income by receiving the near-term income from a financial institution in exchange for allowing the financial institution to use the asset's long-term value as a capital asset of the financial institution without the asset holder relinquishing ownership, control or possession of the asset (ownership, control or possession are sometimes herein summarized as asset “ownership”). The near-term income can comprise one or more items of economic value, such as cash items, or other items of economic value such as, but not limited to, equity in or debt of an enterprise.

The equity referred to above can be any type of ownership interest in an entity. For example, such equity can be common, or various forms of preferred, stock or shares in a corporation, and various interests and rights in and under other entities, such as in and under limited liability companies and in and under partnerships, trusts, and other entities currently or hereafter recognized under applicable law. Further, the debt referred to above can be any form of indebtedness, however and by whomever incurred and by whatever agreement or instrument represented, such as notes, debentures and bonds. One having skill in the art will appreciate that any such equity and debt can respectively be any form of right exercisable in the future to purchase, sell or exchange an ownership interest in an entity or the indebtedness of any entity, such as options, futures, warrants, and swaps. Further, such equity and debt can respectively be any form of hybrid rights and interests having characteristics or attributes of both an ownership interest and debt, which characteristics or attributes may exist simultaneously, such as may exist in preferred stock or shares and in participating debt, or which may exist sequentially, such as may exist in convertible debt and convertible equity.

To monetize the asset, the asset holder negotiates a monetizing transaction with the financial institution. Under the monetizing transaction, the asset holder allows the financial institution to account for the asset on its capital accounts for a period of time, which enables the financial institution to, for example, leverage its increased capital to make additional loans or issue additional insurance policies. In return, the financial institution pays the asset holder at least one negotiated payment for allowing the financial institution to use the value of the asset in accounting for its capital. At the end of the stipulated period of time, the financial institution removes the capital from its capital accounts.

In an illustrative example, an asset holder owns a mine with 50 years of assayed reserves of silver, valued at $50 million, $1 million of which is mined and sold annually. The owner of the mine desires to obtain a first cash payment of $5 million at the beginning of Year 1 and a second cash payment of $5 million at the end of Year 2 to meet various financial requirements. And the mine owner wants to receive the cash payments without the obligation of repaying the amounts received, without substantially risking loss of ownership of the mine, and without ceding business control over the use and exploitation of any of the silver reserves of the mine.

Further, a bank requires additional capital of $20 million to expand its lending program for three years. Under banking laws applicable to the bank, the bank can make total loans of up to five times its capital, or in this case, by an additional $100 million during the three year period after obtaining the additional capital.

The mine owner and the bank negotiate a monetizing transaction satisfying the requirements of the two parties as set forth above. According to the transaction, the bank arranges to have the $20 million of value represented by $20 million of silver reserves (that is, 20 years of reserves of the mine) placed on its capital accounts. In exchange for this arrangement, the bank agrees to make two cash payments to the mine owner: a $5 million payment at the beginning of Year 1 of the transaction period and a $5 million payment at the end of Year 2 of the transaction period. The bank also agrees to pay the mine owner an additional $1 million at the end of Year 3 of the transaction period, representing the yield at a particular interest rate on the capital being made available to the bank during the three year term of the transaction.

At the end of Year 3, the transaction terminates. The bank no longer has available the $20 million additional capital facility previously represented by the value of the mine's asset reserves. However, the bank has profited from the transaction to the extent that it has been able to earn profits on loans totaling $100 million made to its lending customers over and above loans it would otherwise have been able to make but for the additional $20 million in capital the bank had available from participating in the asset monetization transaction. For its part, the asset holder owning the mine has successfully allowed the bank to use the value of the mine's silver reserves and obtained in exchange therefor a total cash payment of $11 million, without relinquishing ownership or control of its asset during the transaction period.

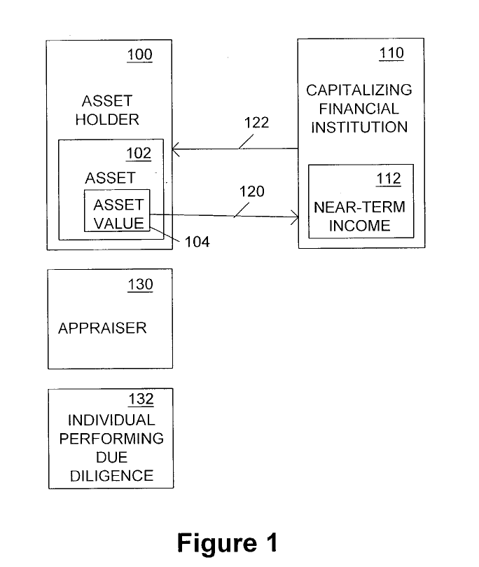

Referring to FIG. 1, FIG. 1 depicts a block diagram of a system for asset monetization in accordance with methods, systems, and articles of manufacture consistent with the present invention. An asset holder 100 is shown holding a qualified asset 102 having an asset value 104. For purposes of this disclosure, “qualified” means any asset, whether comprising tangible, intangible, or mixed property, with a demonstrable and verifiable long-term value at least as great as the value of the near-term income the asset holder seeks to generate from the monetizing transaction.

The asset 102 can be any type of asset. For illustrative purposes, the asset 102 can be one or more of the assets listed below, however, one having skill in the art will appreciate that the asset 102 is not limited thereto. The illustrative assets are grouped into categories to simplify their presentation herein, however, they are categories that are not limiting for purposes of this disclosure. Although the illustrative examples described herein refer to the asset 102 in the singular, one having skill in the art will appreciate that the asset 102 can comprise a plurality of assets that are the subject of monetizing transactions with one or more financial institutions, and that the monetizing transactions may involve the use of asset values of a variety of assets of multiple types. For example, the asset can be one or more of the following:

a. mined and previously exploited and un-mined and otherwise unexploited minerals and materials, of whatever chemical or molecular composition, including for example, precious and semi-precious gems and metals, and rare earths; oil, natural gas, liquid gas, coal, and other materials in gaseous, liquid or solid form that may be used directly or indirectly as an energy source or otherwise for generating energy; stone deposits, including without limitation, granite, marble, and gravels; irons and metals; and sources of chemicals or supplies for use in all useful arts and sciences, such as cement and lime;

b. agricultural products and the real estate on which they grow, be husbanded and be produced, whether farmed or exploited in the wild without specific husbandry procedures, whether such products are useful in and for human activity or enterprise, whether for human or other faunal or floral consumption or use for any purpose and to proven or unproven effect;

C. real estate of any type, improvements thereon, appurtenant items or rights of any value, whether existing on, below or above the ground or grade and all rights, benefits and uses appending thereto (including without limitation leasing or renting all or some portion thereof and exploiting items of value appurtenant thereto), to be or being used or exploited for any purpose or intent;

d. machinery, equipment (including without limitation, computing and related equipment), and transportation equipment (including without limitation, rolling, flying, and sailing stock), and rights and uses appending thereto (including rights of lessors and lessees thereunder), to be or being used or exploited for any purpose or intent;

e. tangible property that can be characterized as fine arts, antiques or collectibles;

f. rights in and under ideas, statements of fact or observation, findings, theories, and theoretical formulation in, under or in respect of any form of human art, science or endeavor, irrespective of the actual or perceived truth or falsity thereof, as may be represented, depicted or expressed in or by any means, including without limitation, by or in any written or verbal communication in words (in any language whatsoever, whether natural, artificial, or idiosyncratic), diagrammatically, mathematically, or algorithmically, or as systems, assemblages, formulas and the like, and set forth in, on or through any media and whether or not published;

g. rights in and under streams of revenues and profits, presently earned or anticipated to be earned in the future, whether such revenue and profit streams are earned or anticipated under specific existing or future contracts and whether they are earned or anticipated without a specific contract existing or being identified (such streams of revenues and profits sometimes being hereinafter referred to as “anticipated earnings”), wherein the rights to, in and under anticipated earnings may be generated by individuals (such as entertainment or sports “personalities”) or enterprises (such as companies with revenue or profit capacities which can be estimated into the future);

h. rights in and under intellectual property, including but not limited to, patents, trademarks, copyrights, trade secrets, shop rights, proprietary information, designs, and know how;

i. rights in and under all forms of methods of, characteristics of or aides to doing business, including without limitation, business names, dba's, trade dresses, advertising slogans and copy and other intellectual property describing, characterizing or denominating a business or intended to create publicity or good will for a business or demand for the business's services or products;

j. rights in and under a literary, pictorial or sculptural, musical or other artistic composition, as contained or represented in or by any media, and as embodied in or by any mode of representation or reproduction, including without limitation live and recorded performance, holographic, manuscript, printed, electronic, film, or other recording or representational format, media, material or substrate, representing an original artistic production or a reproduction as defined within the artistic discipline of which the item is representative, and any rights thereunder, such as copyrights, and the right to turn one form or representation into another form or representation;

k. licenses and franchises representing derivative rights and obligations with respect to the use of any item of property, tangible or intangible, including without limitation, franchises (and the correlative rights of franchisers and franchisees thereunder) including the trademarks, trade dresses, methods of doing business, operating systems and manuals describing or prescribing same, and the contractual rights appertaining thereto; and

l. rights in and under collations, collections, libraries, and portfolios comprising multiple items of tangible or intangible property.

The asset holder 100 has ownership and control of the asset 102, and can also possess the asset. As will be described in more detail below, the asset holder 100 maintains ownership and control of the asset 102 throughout the monetizing transaction. In addition to the near-term income the asset holder 100 receives resulting from the monetizing transaction described below, the asset holder 100 can also realize near-term income from the asset 102 resulting from transactions unrelated to the monetizing transaction, such as, for example, revenues from selling items comprising products or services of or constituting the asset 102, from licensing fees for using asset 102, or revenues otherwise generated from any other economic use or exploitation of asset 102.

The demonstrable and verifiable long-term value of asset 102 qualifies the asset for the below-described monetizing transaction. The long-term value of asset 102 can be any type of value that can be realized over any period of time deemed to be long term by the parties to the asset monetizing transaction. For example, the long-term value may be represented by “M years of reserves” of an extractive asset such as minerals, “N years of patent or copyright protection”, or “P expected revenues generated over Q years”.

The asset holder 100 converts the long-term value of the asset 102 into near-term income (i.e., monetizes the asset) when the asset holder 100 allows a capitalizing financial institution 110 to use at least a portion of the asset's long-term value as a capital asset of the capitalizing financial institution 110 without the asset holder 100 relinquishing ownership or possession of the asset 102. Transferring use of the long-term asset value to the capitalizing financial institution 110 is shown generally by arrow 120. In other words, the capitalizing financial institution 110 accounts for the asset values 104, or portions thereof being monetized, as capital on its capital accounts, while the asset holder 100 maintains ownership and control of the asset 102. In return, the capitalizing financial institution 110 dispenses an agreed upon amount of near-term income 112 to the asset holder 100. The transfer of this near-term income 112 from the capitalizing financial institution 110 to the asset holder 100 is shown generally by arrow 122. One having skill in the art will appreciate that this monetizing transaction is performed to the extent permissible by and in conformity with applicable law.

The capitalizing financial institution 110 enters into the monetizing transaction to increase the capital on its capital accounts. The capitalizing financial institution can be any type of financial institution, including but not limited to, an insurance company and any financial institution authorized under the laws of any jurisdictions to be or act in the capacity of a bank, savings and loan association, trust company, and any other institution denominated or licensed as a bank, savings and loan association or trust company or otherwise authorized to perform or undertake one or more functions generally recognized as banking or trust functions. As described above, conventional equity and debt markets may provide capital to the capitalizing financial institution at a pace slower than the rate at which the financial institution otherwise wants to raise capital. Further, transactions conducted through the conventional markets are typically associated with high transaction costs. The capitalizing financial institution may also find the conventional markets inadequately responsive to its appeals for additional capital, and may price the capital sought by the financial institution unfavorably in relation to the market prices for capital of enterprises in other sectors of the economy

Accordingly, as a supplement or alternative to the conventional capital markets, methods, systems, and articles of manufacture consistent with the present invention enable the financial institution to conduct the monetizing transaction with one or more asset holders, thereby allowing the financial institution to raise capital without resorting to the slower, more costly, or less responsive conventional equity and debt markets. For purposes of this disclosure, it is assumed that applicable banking and insurance laws and rules contemplate and permit capitalization of financial institutions in ways that are independent of the conventional debt and equity funding of a financial institution's capital requirements.

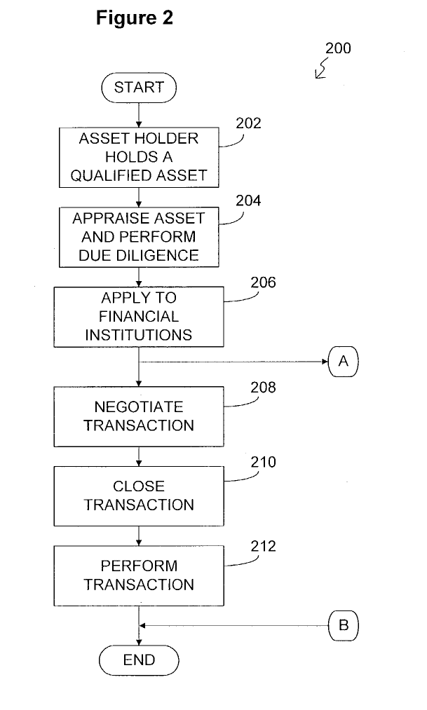

Referring to FIG. 2, FIG. 2 depicts a flow diagram 200 illustrating the exemplary steps for conducting the monetizing transaction of FIG. 1, wherein the asset holder initiates the transaction. One having skill in the art will appreciate that the flow diagrams described herein can comprise additional steps, and that the steps can be executed in sequences that are different than as illustrated. Also, the asset holder and the financial institution can use brokers, consultants, and others who provide assistance and information in respect of a transaction and the various steps thereunder.

In FIG. 2, first, the asset holder holds the qualified asset (step 202).

Then, a person or organization that provides valuation services, such as an appraiser 130, verifies or establishes the values that are being attributed to the asset (step 204). Such a person or organization providing valuation services will likely have professional credentials demonstrating acceptance by the target class of financial institutions of professional expertise, including the appraisal methods used and valuations produced. Also, under step 204, an individual or organization 132, with professional credentials likely demonstrating acceptance of professional expertise, performs other due diligence relating to the asset holder and the asset. For example, This professional verifies claims of ownership and the authenticity and authority of the asset holder. The appraiser and the professional performing due diligence can be selected, for example, by the capitalizing financial institution or by another source. Further, there can be a plurality of appraisers and professionals for performing asset valuation and other due diligence.

The asset holder then applies to one or more capitalizing financial institutions with which it expects to undertake the monetizing transaction (step 206).

Then, the asset holder and the capitalizing financial institution negotiate the terms and conditions of the transfer of the use of the long-term asset value to the capitalizing financial institution and the near-term income to be realized by the asset holder (step 208). In determining the proportion of the long-term asset value to be used by the capitalizing financial institution in the asset monetizing transaction and the amount of near-term income the asset holder is to realize, the capitalizing financial institution and the asset holder evaluate and negotiate with respect to such factors as the nature of the underlying asset, the asset's appraised value, discounts to appraised value, the amount being sought in the transaction as near-term income to the asset holder, the time period over which the asset is expected to remain on the capitalizing financial institution's capital accounts, and the time value of the income being paid to the asset holder and a corresponding yield (interest factor) on the near-term income being paid to the asset holder. One having skill in the art will appreciate that the capitalizing financial institution also refers to the laws applicable to classifying and weighting various asset classes as represented in the capitalizing financial institution's capital accounts; and that the capitalizing financial institution and the asset holder may evaluate other criteria in addition to those described herein.

Assuming that the parties reach an agreement in step 208, the parties execute and deliver (step 210) formal contracts and other documentation that contain or set forth the parties' agreements (sometimes herein such execution and delivery is summarized as to “close” at a “closing”). This documentation may consist of paper or computer substrates. One having skill in the art will appreciate that the parties will seek to conform their agreements to the laws and rules of the jurisdiction governing the capital accounting of the capitalizing financial institution and other applicable laws and rules governing the asset monetizing transaction.

The parties' agreements may, for example, provide that:

a) The capitalizing financial institution shall use the agreed upon portion of the long-term value of the asset on its capital accounts for an agreed period of time.

b) In exchange, the capitalizing financial institution shall pay the asset holder an agreed amount of near-term income, such as cash, over X periods of time (0 to n) at an agreed yield, that may be expressed as an annualized percentage rate of interest.

c) The amount of near-term income received by the asset holder is non-refundable to the capitalizing institution, that is, the asset holder is not required to repay this amount to the capitalizing institution at any time.

d) The asset holder does not give up any indicia of ownership of the subject asset. Alternatively, the asset holder may give up one or more indicia of ownership in ways agreeable to the parties that do not otherwise create conditions that can lead to significant uncontrolled risk of loss of the asset holder's ownership of the asset.

The asset holder and the capitalizing financial institution then perform the transaction (step 212) in conformity with their agreements. In other words, the capitalizing financial institution accounts for the long-term asset value on its asset accounts and, in turn, delivers the agreed upon income to the asset holder in accordance with the monetizing transaction agreements.

Accordingly, the asset holder does not relinquish ownership of the asset, unless otherwise agreed to by the parties. For example, in accordance with methods, systems, and articles of manufacture consistent with the present invention, the asset holder is not selling the asset or pledging a security interest in the asset to secure a loan. Further, the asset holder is not incurring a risk of loss of ownership of the asset it perceives as material in light of the benefits it is expecting to receive by entering into the asset monetization, since the asset holder has not relinquished ownership of the asset to consummate the monetizing transaction and obtain the near-term income. For its part, the capitalizing financial institution has increased its ability to timely raise capital without resorting to conventional equity and debt markets, which might otherwise have been slower, more costly or otherwise less responsive.

In the illustrative example, the capitalizing financial institution had coverage, at the beginning of the transaction, of 2-½ times of the $20 million of the capital it placed on its capital accounts, as represented by the $50 million of mine reserves. Accordingly, the mine's appraiser would have had to be incorrect on the high side regarding the value of the mine's reserves by 2-½ times for the transaction to have been improperly structured. In addition, the capitalizing financial institution's additional capital of $20 million gave the capitalizing financial institution coverage of two times the amount it paid in principal “asset monetization” payments to the mine owner. That is, the capitalizing financial institution had leverage of 2:1 as between its total principal asset monetization payments and the amount of capital placed on its capital accounts. Therefore, the capitalizing financial institutions total principal asset monetization payments of $10 million represented 10% of the additional $100 million it became legally entitled to loan or insure because it entered into the monetizing transaction.

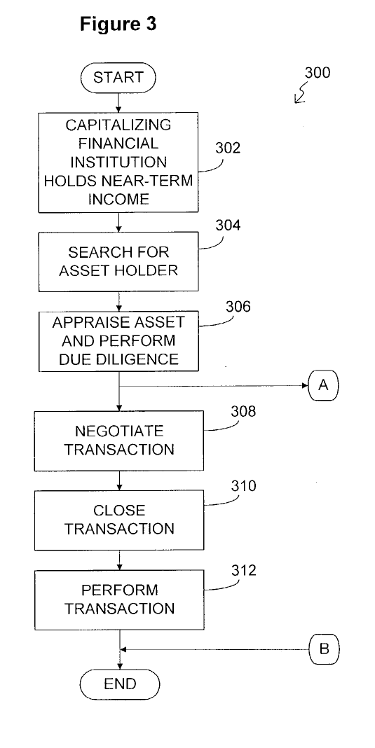

FIG. 3 depicts a flow diagram 300 illustrating the exemplary steps for conducting the monetizing transaction of FIG. 1, wherein the capitalizing financial institution initiates the monetizing transaction. Steps 302-312 of FIG. 3 are similar to steps 202-212 of FIG. 2, however, instead of the asset holder having initiated the monetizing transaction, the capitalizing financial institution is initiating the monetizing transaction. Since the functionality performed in the relevant steps are, for illustrative purposes herein, the same, steps 302-312 will be described briefly below, with more detailed descriptions found above by reference to steps 202-212.

In FIG. 3, first, the capitalizing financial institution holds cash or other items of economic value representing near-term income 112 when delivered to the asset holder (step 302). In other words, the capitalizing financial institution holds, for example, cash, stock or bonds that it can deliver or issue to an asset holder as near-term income 112. This step is similar to step 202, which is described above.

Then, the capitalizing financial institution seeks out one or more asset holders holding qualified assets (step 304). This step is similar to step 206, wherein the asset holder is seeking a capitalizing financial institution with which to engage in an asset monetizing transaction. Further, the capitalizing financial institution approaches one or more such asset holders and proposes to each an asset monetizing transaction that the capitalizing financial institution believes will meet the asset holder's requirements, as well as the capitalizing financial institution's own requirements.

When the capitalizing financial institution finds a prospective asset holder, the financial institution causes the asset to be appraised by the appraiser and the due diligence to be performed (step 306). This step is similar to step 204, which is described above.

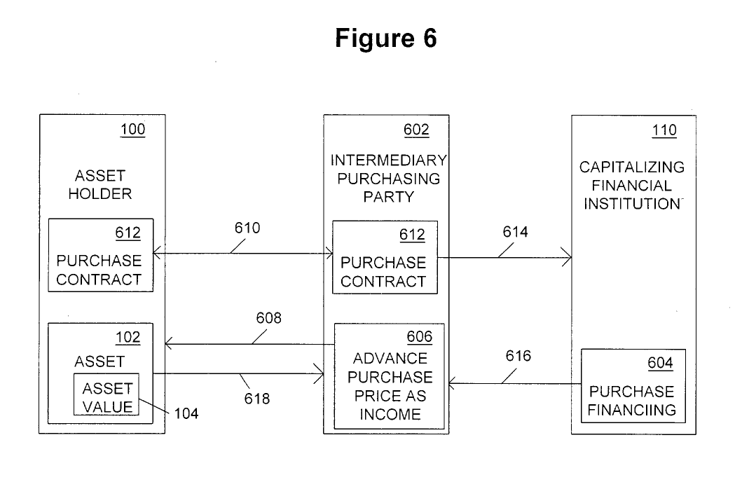

The capitalizing financial institution then negotiates the monetizing transaction with the asset holder (step 308). This step is similar to step 208, which is described above. In addition to the considerations described above with reference to step 208, in step 308, the capitalizing financial institution may require that the asset values not be represented directly on the capitalizing financial institution's capital accounts but indirectly by a financial or other instrument issued by a third party (sometimes hereinafter, the “intermediary”, which can include an “intermediate” financial institution). Such instruments may consist of, for example, asset-backed letters of credit, bank guarantees, or certificates of deposit (or per FIG. 6 as a purchase contract for a portion of the assets 102). Further, the capitalizing financial institution may require that such instruments, such as a letter of credit, be issued “with recourse” to the issuing intermediate financial institution, that is, that the issuing intermediate financial institution is required to pay to the capitalizing financial institution or its representative, such as a conservator in case of the failure or insolvency of the capitalizing financial institution, the amount due under the instrument on the conditions therein stated, regardless of the intermediary's relationship with the asset holder or the asset being monetized.

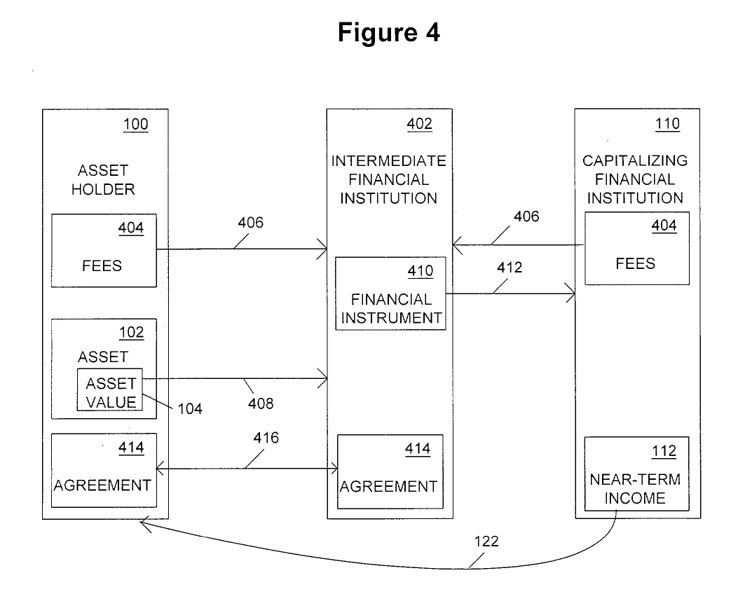

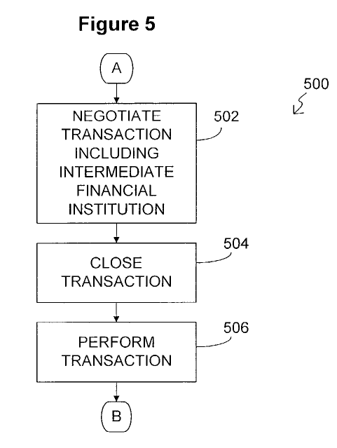

For example, a condition on which the capitalizing financial institution may be allowed to obtain payment under a recourse financial instrument is that the capitalizing financial institution has failed or is otherwise insolvent. Its conservators may then be permitted to seek recourse under the negotiated terms of the financial instrument against the issuing intermediary. That intermediary may then, under any relevant contracts between the issuing intermediary and the asset holder, have recourse to the underlying asset or its value. The parties' use of an intermediary, such as an intermediate financial institution, is described in more detail below with reference to FIGS. 4 and 5.

Assuming that the parties reach an agreement in step 308, the parties execute the formal contracts and other documentation that contain or set forth the parties' agreements (step 310). Step 310 is similar to step 210, which is described above. The asset holder and the capitalizing financial institution then perform the transaction in conformity with their agreements (step 312). In other words, the capitalizing financial institution accounts for the long-term asset values being monetized on its capital accounts and, in turn, delivers the agreed upon near-term income to the asset holder in accordance with the monetizing transaction agreements.

Therefore, the capitalizing financial institution increases the capital in its capital accounts in a timely manner without resorting to the slower, more costly, or less responsive conventional equity and debt markets. And the asset holder obtains near-term income in a timely manner without relinquishing ownership of the asset.

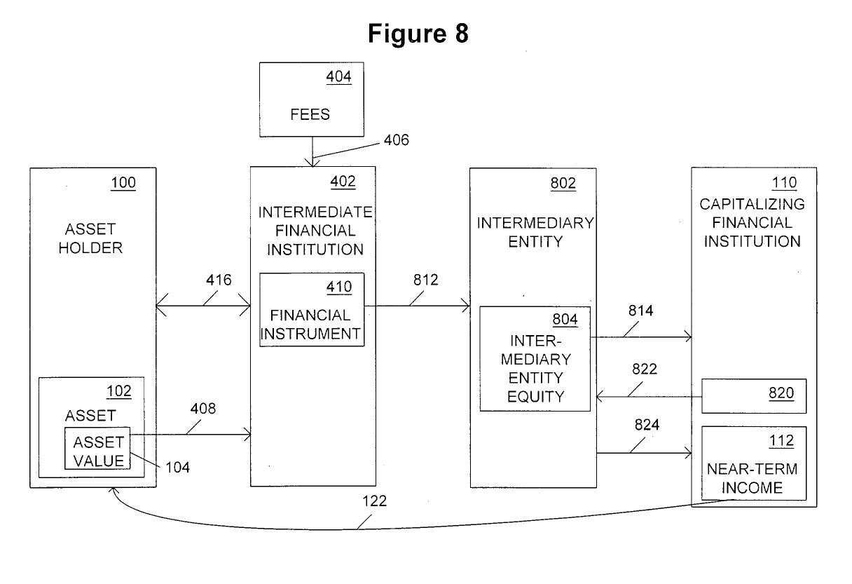

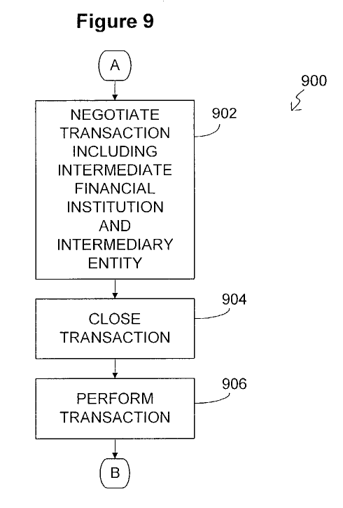

In the illustrative example, the capitalizing financial institution, such as a bank, arranges to have the $20 million of value represented by the mine's reserves on its capital accounts. In the case of a bank, applicable banking laws and regulations, such as those based on or applying the International Convergence of Capital Measurement and Capital Standards that are published by the Basle (sometimes, Basel) Committee on Banking Supervision (so-called Basle, sometimes, Basel, Rules), or any other applicable banking laws and regulations, may require that a bank take onto its capital accounts an equivalent of, or an instrument representing, the asset values, rather than the values themselves, being used by the capitalizing bank as bank capital. For example, the applicable banking laws may require that the capitalizing financial institution hold a financial instrument, such as a letter of credit, as an equivalent or representation of the asset values on its capital accounts. An intermediate financial institution, such as a bank, can issue such a financial instrument. FIG. 4 depicts the illustrative example of FIG. 1 including an intermediate financial institution 402. Alternatively to the above, the applicable laws may provide or require that the value of the asset be placed in an “intermediary entity” in which the bank may hold an equity interest. This embodiment is described in more detail below with reference to FIGS. 8 and 9.

Referring to FIG. 5, FIG. 5 depicts a flow diagram 500 illustrating the exemplary steps for conducting the monetizing transaction of FIG. 2 or FIG. 3, including the intermediate financial institution 402. The steps of flow diagram 500 begin after 206 of FIG. 2 or after step 306 of FIG. 3, as indicated by connector “A”. In FIG. 5, first, the asset holder, the capitalizing financial institution, and the intermediate financial institution negotiate the monetizing transaction (step 502). Step 502 is similar to steps 208 and 308, however, the asset holder 100 and the capitalizing financial institution 110 arrange with the intermediate financial institution 402 to issue, as shown by arrow 412, a financial instrument 410 to the capitalizing financial institution 110 in the amount of that portion of the asset values 104 to be placed on the capital accounts of the capitalizing financial institution. The financial instrument 410 can be, for example, a letter of credit. In the illustrative example, the capitalizing financial institution arranges for a letter of credit in the amount of $20 million.

In exchange for issuing the letter of credit, the intermediate financial institution 402 negotiates a fee 404 that can be paid by the asset holder, or the capitalizing financial institution, or be shared by these parties. In the illustrative example, the intermediate financial institution receives a fee of $500,000 (i.e., a fee of 2-½% of the $20 million in asset values being monetized), where the capitalizing financial institution and the asset holder each pay one-half of the fees.

In order to protect the capitalizing financial institution, it can negotiate that the financial instrument is issued with recourse in favor of the capitalizing financial institution, or its conservators, in, for example, the case where the capitalizing financial institution fails or becomes insolvent. In that case, the intermediate financial institution may be required to pay to the capitalizing financial institution's conservators an amount up to the portion of the asset values 104 being held on the capital accounts of the capitalizing financial institution.

In turn, the intermediary, such as an intermediate financial institution, and the asset holder may seek protection against the risk of being called upon to pay the capitalizing financial institution's conservators under the above-described circumstances. For example, they may seek to do so in one or more of the following ways:

a. Place reliance on the credit rating of the capitalizing financial institutions a rating that is preferably at least as high as the intermediate financial institution's own rating.

b. Arrange that a demand for payment on the letter of credit be made after other items of capital (for example, shareholder equity) are called upon to respond.

c. Arrange between themselves to share all or a portion of the risk in the case of a call by the capitalizing financial institution's conservators.

d. Arrange to obtain financial products insurance (also known as finite insurance), for example, a financial guarantee insurance policy, issued by an insurance underwriter, to cover, in the above-described circumstances, the demands of the capitalizing financial institution's conservators.

e. Cede various limited rights, or otherwise place limitations on the generality of the rights of, various of the parties as among themselves with respect to such matters as realizing upon assets or asset values, realizing upon an intermediary's recourse instrument, or realizing upon the intermediary purchasing party's asset purchase contract (as described in FIG. 6 below).

f. Securitize the asset monetizing transaction. That is, the asset monetizing transaction can be converted into a financial investment product the interests under which can be sold in private and public securities sales transactions, producing additional income for one or more of the parties at risk, thus offsetting a portion of the risk of loss.

One having skill in the art will appreciate that intermediaries, such as intermediate financial institutions, and asset holders can seek risk mitigation in ways other than those listed above.

After the parties negotiate the transaction in step 502, the parties document the transaction in a manner similar to the closing described above with reference to steps 210 and 310 (step 504).

Then, the parties perform the transaction (step 506). The intermediate financial institution issues and transfers the financial instrument 410 to the capitalizing financial institution, as indicated by arrow 412, to be held on the capitalizing financial institution's capital accounts. In return, the asset holder, the capitalizing financial institution, or both, pay the fee 404 to the intermediate financial institution, as indicated by arrows 406. In addition, the asset holder and the intermediate financial institution will have a contractual relation and bilateral agreements 414 regarding the asset values backing the financial instrument and other matters, as indicated by the double-headed arrow 416. Also, the capitalizing financial institution pays the near-term income 112 to the asset holder, as indicated by arrow 122, for having the equivalent of the asset values being monetized on the capitalizing financial institution's capital accounts.

The intermediary can be other than an intermediate financial institution. For example, it may be difficult for the asset holder and capitalizing financial institution to find an intermediate financial institution willing to issue a financial instrument with recourse in favor of the capitalizing financial institution. For this, or other reasons, a third party intermediary may be available to intermediate the transaction. For example, a third party intermediary may enter into a contract with an asset holder to purchase some portion of the asset 102 at a given time in the future (such a third party intermediary sometimes herein, an “intermediary purchasing party”). The purchase contract is then funded by the capitalizing financial institution's payment to the asset holder, as the intermediary purchasing party directs, of a forward funding or advance payment in respect of the portion of the asset 102 being purchased under the purchase contract. Such payment(s) represent near-term income to the asset holder. The intermediary purchasing party may earn a fee for brokering the transaction and may earn a profit (or suffer a loss) on the purchase transaction. In an embodiment, the total value of the amount of the asset 102 being purchased under the purchase contract may be equal to, but may be less than, the advance purchase price paid to the asset holder.

FIG. 6 depicts the illustrative example of FIG. 1 including an intermediary purchasing party 602.

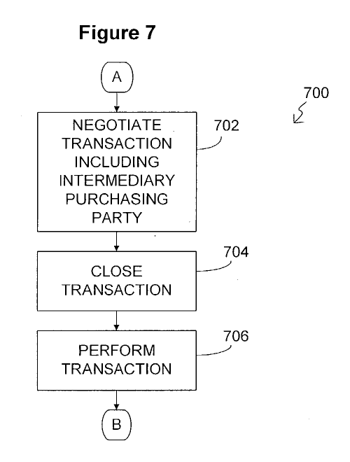

FIG. 7 depicts a flow diagram 700 illustrating the exemplary steps for conducting the monetizing transaction of FIG. 2 or FIG. 3, including the intermediary purchasing party 602. The steps of flow diagram 700 begin after 206 of FIG. 2 or after step 306 of FIG. 3, as indicated by connector “A”. In FIG. 7, first, the asset holder, the capitalizing financial institution, and the intermediary purchasing party negotiate the monetizing transaction (step 702). Step 702 is similar to steps 208 and 308, however, the asset holder and purchasing party enter into an advance payment or forward purchase contract 612, wherein the purchasing party agrees to purchase, and the asset holder agrees to sell, a given quantity of the asset 102 held by the asset holder for delivery to the purchasing party in the future at specified or unspecified dates. The bilateral nature of the purchase contract is depicted by double-headed arrow 610. The intermediary purchasing party arranges with the capitalizing financial institution for purchase financing 604 to fund its purchase of the specified portions of asset 102. As a condition of the purchase contract, the intermediary purchasing party and asset holder may negotiate that deliveries to the intermediary purchasing party of the purchased quantities of the asset 102 do not occur prior to tendering payment of the advance purchase price for the corresponding portion of the purchased quantity of the asset, such payment 606 representing near-term income to the asset holder.

After the parties negotiate the transaction in step 702, the parties document the transaction in a manner similar to the closing described above with reference to steps 210 and 310 (step 704).

Then, the parties perform the transaction (step 706). The intermediary purchasing party assigns the purchase contract 612 to the capitalizing financial institution, as indicated by arrow 614, to hold as capital on its capital accounts. Alternatively, the purchasing party can assign the purchase contract 612 to an “intermediary entity” in which the capitalizing financial institution may hold an equity interest (as described in FIGS. 8-10 below). In return, the capitalizing financial institution issues the purchase financing 604 to the intermediary purchasing party, as indicated by arrow 616. Then, at specified or unspecified times, the intermediary purchasing party (or the capitalizing financial institution on behalf of the intermediary purchasing party) makes one or more advance purchase payments 606, as indicated by arrow 608, to the asset holder. Such advance payments 606 represent near-term income to the asset holder. Further, at other specified or unspecified times, the purchasing party obtains delivery of the purchased quantities of the asset 102 from the asset holder, as indicated by arrow 618.

In another embodiment, in addition to the use of an intermediary, such as an intermediate financial institution or intermediary purchasing party, the parties use an intermediary entity in the asset monetization transaction. FIG. 8 depicts the illustrative example of FIG. 4 including the intermediate financial institution 402 and an intermediary entity 802. FIG. 9 depicts a flow diagram 900 illustrating the exemplary steps for conducting the monetizing transaction of FIG. 2 or 3, including the intermediate financial institution 402 and the intermediary entity 802. The steps of flow diagram 900 begin after step 206 of FIG. 2 or after step 306 of FIG. 3, as indicated by connector “A”.

In FIG. 9, first, the asset holder, the capitalizing financial institution, the intermediate financial institution, and the intermediary entity negotiate the monetizing transaction (step 902). Step 902 is similar to steps 208 and 308; however, the intermediate financial institution and the intermediary entity intermediate the transaction as between the asset holder and the capitalizing financial institution. The asset holder 100 and capitalizing financial institution 110 arrange with the intermediate financial institution 402 to issue the financial instrument 410 to the intermediary entity 802 in the amount of the asset values to be placed on the capitalizing financial institution's capital accounts. The intermediary entity is any type of legal entity, such as a corporation or trust. Such intermediary entities have sometimes been called “special purpose vehicles”, but they may have other functional designations. Such intermediary entities are known to one having skill in the art and will not be described in more detail herein. As described above, the financial instrument 410 can be, for example, a letter of credit. In the illustrative example, the capitalizing financial institution arranges for a letter of credit in the amount of $20 million.

In exchange for issuing the letter of credit, the intermediate financial institution 402 negotiates a fee 404, payment of which may be made by the asset holder or the capitalizing financial institution, or shared by both. In the illustrative example, the intermediate financial institution receives a fee of $500,000 (i.e., a fee of 2-½% of the $20 M of asset values being monetized), where the capitalizing financial institution and the asset holding mine owner each pay one-half of the fee.

In return for being issued the financial instrument having asset values representing that portion of the asset being monetized, the intermediary entity issues an equity interest in the form of, for example, equity 804 in the intermediary entity 804 to the capitalizing financial institution. The equity 804 has a value substantially equal to the value of the financial instrument. Accordingly, the capitalizing financial institution holds equity approximately equivalent to the values under the financial instrument 410, which in turn reflect that portion of the asset values 104 that are being monetized. This equity is then held as capital on the capitalizing financial institution's capital accounts.

Alternatively, or in addition to the foregoing, in return for being issued the financial instrument by the intermediate financial institution having asset values representing at least that portion of the asset being monetized, the capitalizing financial institution issues to the intermediary entity debt under a debt instrument 820. The debt instrument 820 has a value substantially equal to the value of the financial instrument issued by the intermediate financial institution. Accordingly, the capitalizing financial institution owes the intermediary entity under the debt instrument 820 and accounts for the value of the financial instrument 410 as capital on its capital accounts, which in turn represents the value of that portion of the asset values being monetized. Further, the capitalizing financial institution can issue the debt instrument 820 in the other embodiments as described below and elsewhere herein with reference to the other Figures.

The equity 804 is any type of ownership interest in an entity. For example, the equity 804 can be common, or various forms of preferred, stock or shares in a corporation, and various interests representing ownership in and under other entities, such as in and under limited liability companies, partnerships, trusts, and other entities currently or hereafter recognized under applicable law. Further, the debt 820 is any form of indebtedness, however and by whomever incurred and by whatever agreement or instrument represented, such as notes, debentures and bonds. Such indebtedness may be super-ordinate or subordinated to other liabilities or obligations of the debtor and may be characterized by a variety of other rights and obligations as creditors and debtors may negotiate. One having skill in the art will appreciate that the equity 804 and subordinated debt 820 can respectively be any form of right exercisable in the future to purchase, sell or exchange an ownership interest in an entity or the indebtedness of any entity, such as options, futures, warrants, and swaps. Further, the equity 804 and subordinated debt 820 can respectively be any form of hybrid rights and interests having characteristics or attributes of both an ownership interest and debt, which characteristics or attributes may exist simultaneously, such as may exist in preferred stock or shares and in participating debt, or which may exist sequentially, such as may exist in convertible debt and convertible equity.

Similar to the embodiment depicted in FIG. 4, the intermediary entity may negotiate to protect itself by negotiating for the issuance of the financial instrument with recourse in favor of the intermediary entity. In turn, the intermediary, such as an intermediate financial institution, and the asset holder may negotiate for protection against the risk of being called upon to make a payment to the intermediary entity or the capitalizing financial institution's conservators, in case, for example, of the failure or insolvency of the capitalizing financial institution. The intermediate financial institution and asset holder may negotiate for protection in one or more of the ways described above in FIG. 4, with reference to demands for payment under the above circumstances from the intermediary entity or the conservators of the capitalizing financial institution.

After the parties negotiate the transaction in step 902, the parties then close and perform the transaction (steps 904 and 906) in a manner as described above with reference to steps 210 and 310 and steps 212 and 312.

The intermediate financial institution issues and transfers the financial instrument 410 to the intermediary entity, as indicated by arrow 812, to be held by the intermediary entity. In return, the intermediate financial institution is paid fees 404, the payment of which may be made by the asset holder, or the capitalizing financial institution, or shared by both, as indicated by arrows 406 as in FIG. 4. In addition, the asset holder and the intermediate financial institution enter into a contractual relation and agreements 414 regarding the asset values backing the financial instrument and other matters, as indicated by arrow 416, as in FIG. 4. Also, the intermediary entity issues the equity 804 for the asset values being monetized to the capitalizing financial institution, as indicated by arrow 814. In exchange, the capitalizing financial institution pays the near-term income 112 to the asset holder, as indicated by arrow 122, for having the equivalent of the portion of the asset values 104 on its capital accounts. As described above, alternatively, or in addition to the foregoing, in return for being issued the financial instrument by the intermediate financial institution having the value of at least the portion of the asset values being monetized, the capitalizing financial institution issues subordinated debt under the debt instrument 820 to the intermediary entity, as indicated by arrow 822. The debt instrument 820 has a value substantially equal to the value of the financial instrument issued by the intermediate financial institution. Accordingly, the capitalizing financial institution owes the intermediary entity under the debt instrument 820, as indicated by arrow 822, and accounts for the value of the financial instrument as capital on its capital accounts, as indicated by arrow 824, which in turn represents the portion of the asset values 104 being monetized.

In an embodiment, any one or more of the parties to the transaction can comprise a plurality of parties. That is, any one or more asset holders, intermediate financial institutions, intermediary entities, or capitalizing financial institutions can comprise a plurality of entities, such as, for example, a consortium of any of such parties. Further, one having skill in the art will appreciate that there can be one or more intermediaries of the same type or dissimilar type, other than those described above involved in the transaction.

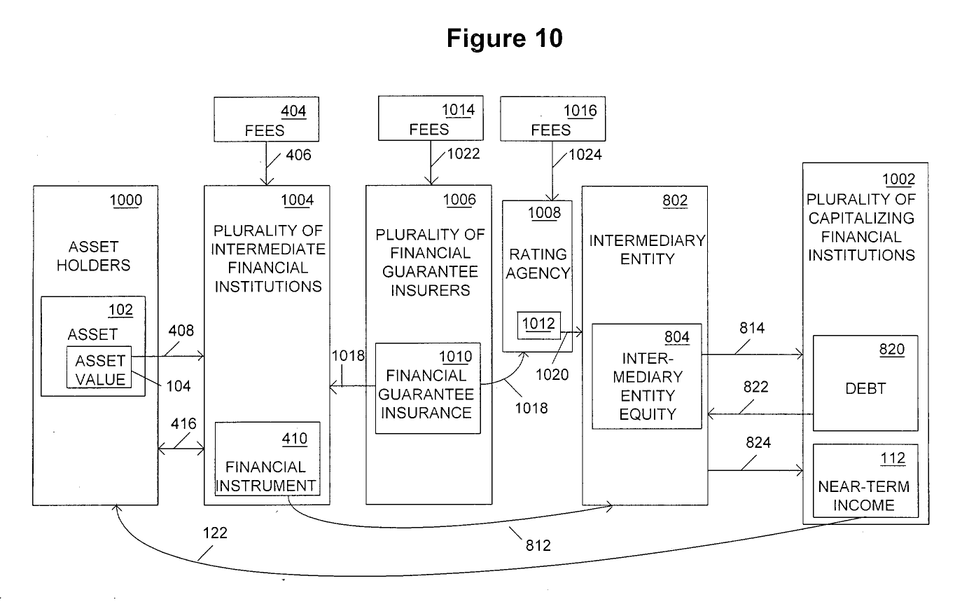

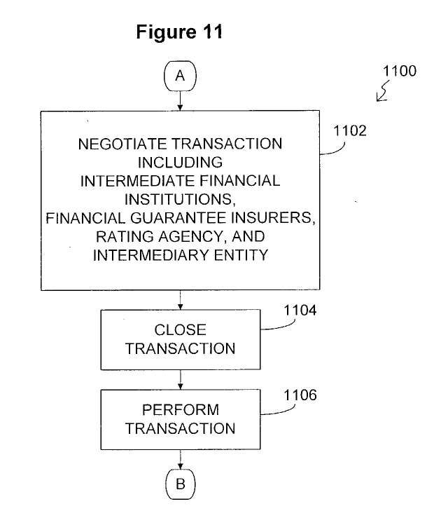

Referring to FIGS. 10 and 11, for example, a plurality of asset holders 1000 conduct a monetizing transaction with a plurality of capitalizing financial institutions 1002. In the depicted example of FIG. 10, intermediaries to the monetizing transaction comprise a plurality of intermediary financial institutions 1004, a plurality of financial guarantee insurers 1006, a rating agency 1008, and the intermediary entity 802. FIG. 11 depicts a flow diagram 1100 illustrating the exemplary steps for conducting the monetizing transaction of FIG. 2 or 3, including the intermediate financial institutions depicted in FIG. 10. The steps of flow diagram 1100 begin after step 206 of FIG. 2 or after step 306 of FIG. 3, as indicated by connector “A”.

In FIG. 11, first, asset holders 1000, capitalizing financial institutions 1102, and intermediaries, such as intermediate financial institutions 1004, financial guarantee insurers 1006, and intermediary entity 802, negotiate the monetizing transaction (step 1102). Step 1102 is similar to steps 208 and 308; however, the various additional parties, are as illustratively shown in FIG. 10. The capitalizing financial institutions 1002 arrange with the intermediate financial institutions 1004 to issue the financial instrument 410 to the intermediary entity 802 in the amount of the portion of the asset values 104 being monetized. In exchange for issuing the financial instrument, the intermediary financial institutions 1004 negotiate a fee 404, the payment of which may be made by or among any one or more of the transaction parties.

In return for being issued the financial instrument having a value of at least a portion of the asset from the intermediate financial institution, the intermediary entity issues an equity interest in the form of, for example, stock in the intermediary entity 802 to the capitalizing financial institutions. The equity 804 has a value substantially equal to the value of the financial instrument. Accordingly, the capitalizing financial institution holds equity approximately equivalent to the values under the financial instrument 410, which in turn reflect that portion of the asset values 104 that are being monetized. This equity is then held as capital on the capitalizing financial institution's capital accounts.

Alternatively, or in addition to the foregoing, in return for being issued the financial instrument by the intermediate financial institutions having a value of at least a portion of the asset being monetized, the capitalizing financial institutions issue subordinated debt under a debt instrument 820 to the intermediary entity. The debt instrument 820 has a value substantially equal to the value of the financial instrument issued by the intermediate financial institutions. Accordingly, the capitalizing financial institutions owe the intermediary entity under the debt instrument 820 and account for the value of the financial instrument as capital on their capital accounts, which in turn represents the portion of the asset values 104 being monetized.

Further, the parties negotiate that the financial guarantee insurers 1006 issue at least one financial guarantee policy 1010 in favor of the intermediate financial institutions and the asset holders to mitigate risk and to credit enhance the financial instrument vis-a-vis the rating agency 1008. The rating agency 1008 issues a rating 1012 for the financial instrument that is held by the intermediary entity 802. The rating 1012 is based in part on the issuance, if any, of the financial guarantee policy 1010. The financial guarantee insurance and the rating of financial instruments are known to one having skill in the art and will not be described in more detail herein. In return for providing their services, the financial guarantee insurers receive a fee 1022 (e.g., an insurance premium) and the rating agency receives a fee 1024 paid by one or more of the other parties to the monetizing transaction.

As described above with reference to FIG. 4, the intermediary entity may negotiate to protect itself by negotiating that the financial instrument is issued with recourse in favor of the intermediary entity. Also, the intermediate financial institutions and asset holders may negotiate to protect against the risk of being called upon to make a payment to the conservators of a capitalizing financial institution that is failing or has become insolvent.

After the parties negotiate the transaction in step 1102, the parties then close and perform the transaction (steps 1104 and 1106) in a manner as described above with reference to steps 210 and 310 and steps 212 and 312.

Accordingly, the intermediate financial institutions issue and transfer the financial instrument 410 to the intermediary entity, as indicated by arrow 812, to be held by the intermediary entity. In exchange for issuing the financial instrument, the intermediary financial institutions 1004 negotiate a fee 404, the payment of which may be made by or among any one or more of the transaction parties, as indicated by arrow 406. In addition, the asset holders and the intermediaries, such as the intermediate financial institutions, enter into contractual relations and agreements regarding the asset values backing the financial instrument and other matters, as indicated by arrow 416.

The financial guarantee insurers 1006 issue a financial guarantee insurance policy 1010 issue in favor of the intermediate financial institutions, as indicated by arrow 1018. Also, the rating agency 1008, relying in part on the issuance of the financial guarantee policy, if any, issues a rating 1012 of the financial instrument, as indicated by arrow 1020. For their parts, the financial guarantee insurers receive their fee, in the form of an insurance premium, as indicated by arrow 1022, and the rating agency receives its fee, as indicated by arrow 1024.

Also, the intermediary entity issues the equity 804 in the approximate amount of the portion of the asset values being monetized, as indicated by arrow 814. In exchange, the capitalizing financial institutions pay the near-term income 112 to the asset holder, as indicated by arrow 122, for having the equivalent of the asset values on their capital accounts.

As described above, alternatively, or in addition to the foregoing, in return for being issued the financial instrument by the intermediate financial institutions representing the portion of the asset values being monetized, the capitalizing financial institutions issue debt (which indebtedness may be super-ordinate or subordinated to other liabilities or obligations of the debtor and may be characterized by a variety of other rights and obligations as creditors and debtors may negotiate.) under a debt instrument 820 to the intermediary entity. The debt instrument 820 has a value substantially equal to the value of the financial instrument issued by the intermediate financial institutions. Accordingly, the capitalizing financial institution owes the intermediary entity under the debt instrument 820, as indicated by arrow 822, and accounts for the value of the financial instrument as capital on its capital accounts, as indicated by arrow 824, which in turn represents the value of that portion of the asset values 104 being monetized.

As described above with respect to other embodiments, one having skill in the art will appreciate that the rights and obligations between and among the asset holders, the capitalizing financial institutions, the intermediaries, such as the intermediary purchasing party or parties and the intermediate financial institutions, the financial guarantee insurers, and the intermediary entity may be subject to risks. Each of the parties to the monetizing transaction, on its own behalf, by contracts with one or more of the other parties, or by contracts with one or more third parties, can mitigate any such risks as are perceived to be inimical to their interests in and under the asset monetizing transaction, as described above.

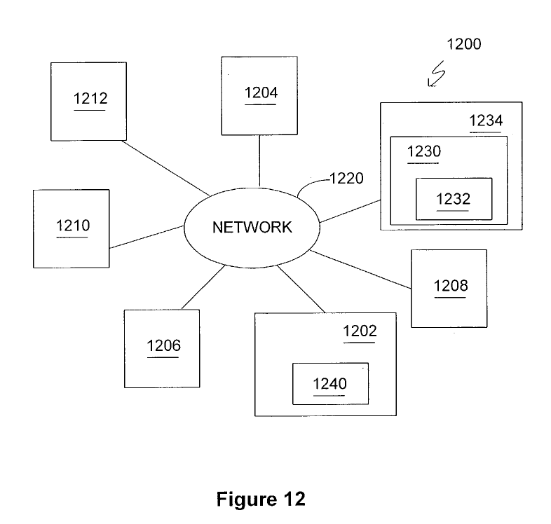

FIG. 12 depicts a block diagram of a data processing system 1200 suitable for use with practicing methods and implementing systems for asset monetization consistent with the present invention. The data processing system 1200 comprises a plurality of computer systems 1202-1212 that communicate via a network 1220. The network can be, for example, the Internet or a proprietary or secure network. As shown, there are computer systems for the capitalizing financial institution 1202, the asset holder 1204, the intermediate financial institution 1206, the purchasing party 1208, the appraiser 1210, and the individual for performing due diligence 1212. One having skill in the art will appreciate that not all of these computer systems are required to perform a monetizing transaction, for example, if there is no purchasing party involved in the transaction, then the purchasing party computer system 1208 is not required, and that these computer systems are not required to be dedicated solely to performing these transactions.

The computer systems can comprise any suitable data processing device for performing methods and implementing systems consistent with the present invention. For example, any one of the computer systems can comprise one or more servers, clients, terminals, or other types of computing devices.

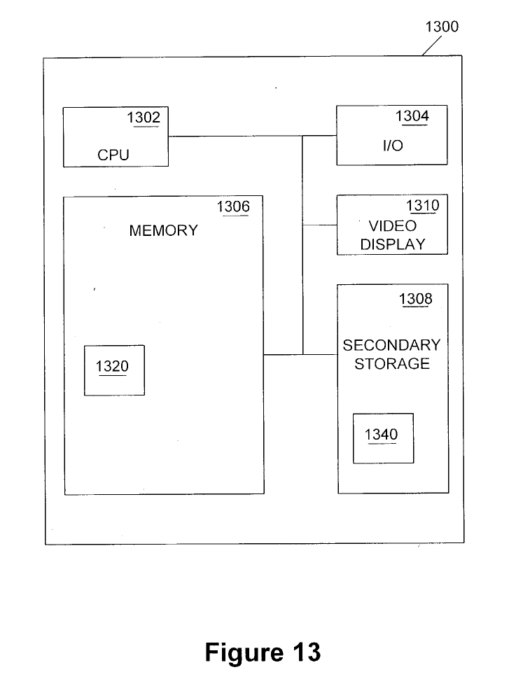

FIG. 13 depicts a block diagram of the capitalizing financial institution computer system 1202 in more detail. One having skill in the art will appreciate that the other computer systems can be similar to computer system 1202. The computer system 1202 comprises a central processing unit (CPU) 1302, an input output I/O unit 1304, a memory 1306, a secondary storage device 1308, and a video display 1310. The computer system 1202 may further comprise standard input devices such as a keyboard, a mouse or a speech processing means (each not illustrated).

The memory 1306 contains a capitalizing financial institution program 1320 for processing the asset monetization transaction.

Each of the programs in memory will be described in more detail below. The programs may comprise or may be included in one or more code sections containing instructions for performing their respective operations. While the programs are described as being implemented as software, the present implementation may be implemented as a combination of hardware and software or hardware alone. Also, one of skill in the art will appreciate that programs may comprise or may be included in a data processing device, which may be a server, communicating with the computer system.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROMs; a carrier wave received from a network such as the Internet; or other forms of ROM or RAM either currently known or later developed. Further, although specific components of data processing system 1200 are described, one skilled in the art will appreciate that a data processing system suitable for use with methods, systems, and articles of manufacture consistent with the present invention may contain additional or different components.

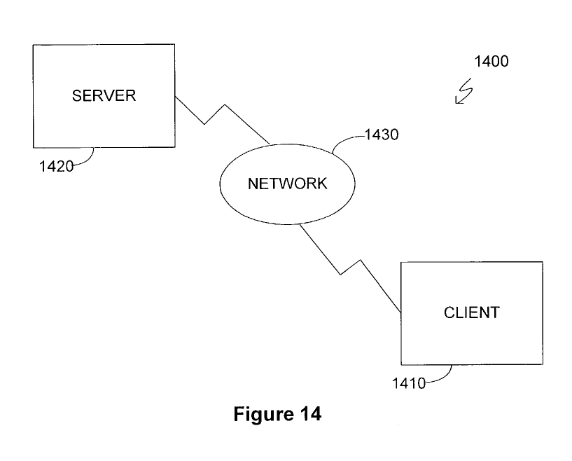

One skilled in the art will appreciate that methods, systems, and articles of manufacture consistent with the present invention may also be implemented in a client-server environment, like the one depicted in FIG. 14. FIG. 14 depicts a block diagram of a client-server based data processing system 1400 with which methods, systems, and articles of manufacture consistent with the present invention may be implemented. A client computer system 1410 and a server computer system 1420 are each connected to a network 1430, such as a Local Area Network, Wide Area Network, or the Internet. At least a portion of, for example, the capitalizing financial institution program can be stored on client computer system 1410 while some or all steps of the processing as described below can be carried out on server computer system 1420, which is accessed by client computer system 1410 over network 1430. Client computer system 1410 and server computer system 1420 can each comprise components similar to those described above with respect to computer system 1202, such as a CPU, an I/O, a memory, a secondary storage, and a video display.

Referring back to FIG. 12, a data base 1230, which is for example located on a data base server 1234, is also connected to the network. The database 1230 contains at least one data item 1232 about the asset. The data item 1232 comprises, for example, a location of the asset, a description of the asset, legal rights associated with the asset, contract information, and relevant electronic signatures. In the illustrative example, the data item 1232 comprises information relating to the silver mine, such as chain of title. For purposes of a monetizing transaction, a user can enter the data 1232 into the database 1230 if it is not already there.

The asset holder has access to the database 1230, and provides access to others to effect the monetizing transaction. For example, the asset holder grants access to the appraiser and the other individual performing due diligence, so that they may perform the appraisal and other due diligence for the transaction.

FIG. 12 also depicts data 1240 located in memory or on a secondary storage device of the capitalizing financial institution's computer system 1202. Data 1240 relates to the capitalizing financial institution's capital accounts. During execution of the monetizing transaction, the data 1240 is updated to reflect the addition of capital on the capital account to the extent of the predetermined value of the asset. The capitalizing financial institution and any intermediary can then use a record of the updated data 1240 for reporting to regulatory agencies with respect to the monetizing transaction.

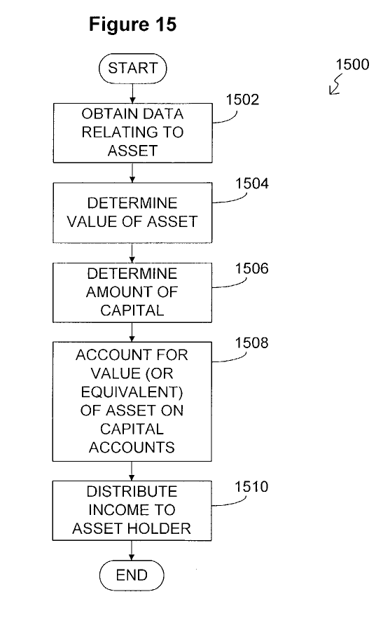

FIG. 15 depicts a flow diagram 1500 illustrating exemplary steps performed by the capitalizing financial institution program for processing an asset monetization in accordance with methods, systems, and articles of manufacture consistent with the present invention. First, the program receives information relating to the asset (step 1502). This information is received, for example, from the database or through user input. The information is, for example, the data item 1232, which is described above.

Then, the program determines a value of the asset for purposes of the monetizing transaction (step 1504). This determination can be made using information, which is provided by the appraiser or other individual performing due diligence, and inputted into the data processing system. Further, the program can use any suitable criteria or information for determining the transactional value of the asset, such as historical data, a mathematical algorithm, or user input.

The program then determines the amount of additional capital to be accounted for on the capital accounts (step 1506). The program can make this determination through a user input or through a computation. After the negotiations of the parties are completed, the program accounts for the value of the asset (or the operative transactional value of the asset) on the capitalizing financial institution's capital accounts (step 1508). Accordingly, the program then effects or indicates approval of the distribution of the income to the asset holder, schedules the distribution of the income, and effects distribution of the income (step 1510). Accounting for the value of the asset (or its equivalent) and the distribution of the income in steps 1508 and 1510, respectively, is described in more detail above with reference to steps 212 and 312.

Methods, systems, and articles of manufacture consistent with the present invention provide an alternative to the asset holder holding qualified assets to obtain or enhance near-term income generated by, or with reference to, the asset independent of current sales or other exploitation of the asset, while enjoying a significantly reduced (and controllable) risk of losing ownership or control of the asset. In addition, the asset holder will not be obligated to repay or refund the near-term income so generated. They also provide an alternative to financial institutions to generate a source of capital. This supports the financial institution's capacity to expand its normal course business activities, such as, for example, extending additional loans or issuing additional insurance policies.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed:

1. A method for monetizing an asset having a long-term value, the method comprising the steps of:
accounting for at least a portion of the long-term value of the asset as capital on a capital account of a financial institution for a period of time; and
distributing an income to an owner of the asset during the period of time responsive to the accounting for the long-term value of the asset as capital on the capital account, wherein the owner of the asset maintains ownership of the asset during the period of time.

2. The method of claim 1, further comprising the step of:
determining a value of at least the portion of the long-term value of the asset.

3. The method of claim 1, further comprising the step of:
determining an amount of at least the portion of the long-term value of the asset to account for as capital on the capital account.

4. The method of claim 1, further comprising the step of:
determining a value of the income to distribute to the owner.

5. The method of claim 1, further comprising the step of:
effecting a contract between the financial institution and the owner of the asset for the accounting of at least the portion of the long-term value of the asset as capital on the capital account and the distribution of the income.

6. The method of claim 1, wherein the asset comprises at least one of the group consisting of a mined mineral, an un-mined mineral, a mined material, and an un-mined material.

7. The method of claim 1, wherein the asset comprises an agricultural product.

8. The method of claim 1, wherein the asset comprises a real estate asset.

9. The method of claim 1, wherein the asset comprises at least one of the group consisting of a machine, an item of equipment, a right to or under a machine, a right to or under an item of equipment, a use of a machine, and a use of an item of equipment.

10. The method of claim 1, wherein the asset comprises tangible property selected from the group consisting of a fine art piece, an antique, and a collectable.

11. The method of claim 1, wherein the asset comprises a right in at least one of the group an idea, a statement of fact, an observation, a finding, a theory, and a formula.

12. The method of claim 1, wherein the asset comprises a right in at least one of the group consisting of a current revenue, a current profit, a future revenue, and a future profit.

13. The method of claim 1, wherein the asset comprises an intellectual property right in at least one of the group consisting of a patent, a trademark, a copyright, a trade secret, a trade name, a design, trade dress, and a know how.

14. The method of claim 1, wherein the asset comprises an advertising slogan.

15. The method of claim 1, wherein the asset comprises a right in at least one of the group consisting of a literary work, an artistic work, and a musical work.

16. The method of claim 1, wherein the asset comprises at least one of the group consisting of a license and a franchise.

17. The method of claim 1, wherein the asset comprises a right in at least one of the group consisting of a collation, a collection, a library, and a portfolio.

18. The method of claim 1, wherein the financial institution is a bank.

19. The method of claim 1, wherein the financial institution is an insurance company.

20. The method of claim 1, wherein the income comprises cash.

21. The method of claim 1, wherein the income comprises an item of debt.

22. The method of claim 21, wherein the income comprises a debt instrument.

23. The method of claim 1, wherein the income comprises at least one of an item of equity and a holding of debt

24. The method of claim 23, wherein the income comprises at least one of a certificate and an electronic entry indicating equity ownership or holding of debt.

25. The method of claim 23, wherein the income comprises at least one of common stock, preferred stock, a share in a corporation, an ownership interest, an interest or right in a corporation, an interest or right in a company, and interest or right in a limited liability company, an interest or right in a trust, an interest or right in a partnership, an interest or right in an s-corporation, a note, a bond, and a note or a bond with a right to convert the debt thereby represented into an ownership interest.

26. The method of claim 23, wherein the income comprises a right exercisable at a time after the income is provided.

27. The method of claim 26, wherein the income comprises at least one of an option, a future, a warrant, and a swap.

28. The method of claim 1, wherein the step of accounting for at least the portion of the long-term value of the asset as capital on the capital account of the financial institution for the period of time comprises:
accounting for an equivalent of the value of at least the portion of the long-term value of the asset by accounting for a financial instrument as capital on the capital account.

29. The method of claim 28, wherein the financial instrument is at least one of the group consisting of a letter of credit, a financial guarantee, and a certificate of deposit.

30. The method of claim 28, wherein an intermediary issues the financial instrument to the financial institution.

31. The method of claim 30, wherein the financial instrument is issued with recourse to the issuing intermediary.

32. The method of claim 1, wherein the step of accounting for at least the portion of the long-term value of the asset as capital on the capital account of the financial institution for a period of time comprises:
accounting for an equivalent of the value of at least the portion of the long-term value of the asset by accounting for the value as an asset of an intermediary entity in which the capitalizing financial institution holds an equity interest.

33. The method of claim 1, wherein the financial instrument is an assignment of a purchase contract for the asset.

34. The method of claim 33, wherein the income is distributed to the owner of the asset from, or at the direction of, a purchasing party who enters into the purchase contract with the owner of the asset for a purchase of a portion of the asset at one of the group consisting of a predetermined date and a non-pre-determined date.

35. The method of claim 34, wherein the predetermined date is at the expiration of the period of time during which the transaction remains in effect.

36. The method of claim 1, wherein the income is distributed to the owner of the asset by a party other than the financial institution.

37. The method of claim 1, wherein the income is distributed to the owner of the asset by the financial institution.

38. The method of claim 1, further comprising the step of:
using the capital on the capital account to leverage a loan.

39. The method of claim 1, further comprising the step of:
using the capital on the capital account to leverage an insurance policy.

40. The method of claim 1, further comprising the step of:
using a broker to broker a transaction involving the accounting for at least the portion of the long-term value of the asset as capital on the capital account and the distributing of the income to the owner of the asset.

41. A method in a data processing system having a program, the method comprising the steps performed by the program of:
accounting for at least a portion of a long-term value of an asset as capital on a capital account of a financial institution for a period of time; and
distributing an income to an owner of the asset during the period of time responsive to the accounting for the long-term value of the asset as capital on the capital account, wherein the owner of the asset maintains ownership of the asset during the period of time.

42. The method of claim 41, further comprising the step of:
determining a value of at least the portion of the long-term value of the asset.

43. The method of claim 41, further comprising the step of:
determining an amount of at least the portion of the long-term value of the asset to account for as capital on the capital account.

44. The method of claim 41, further comprising the step of:
determining a value of the income to distribute to the owner.

45. The method of claim 41, wherein the step of accounting for at least the portion of the long-term value of the asset as capital on the capital account of the financial institution for the period of time comprises:
accounting for an equivalent of a value of at least the portion of the long-term value of the asset by accounting for a financial instrument as capital on the capital account.

46. The method of claim 41, wherein the step of accounting for at least the portion of the long-term value of the asset as capital on the capital account of the financial institution for a period of time comprises:
accounting for an equivalent of the value of at least the portion of the long-term value of the asset by accounting for the value as an asset of an intermediary entity in which the capitalizing financial institution obtains an equity interest.

47. The method of claim 41, wherein the step of accounting for at least the portion of the long-term value of the asset as capital on the capital account of the financial institution for a period of time comprises:
accounting for an equivalent of the value of at least the portion of the long-term value of the asset by accounting for the value as an asset of an intermediary entity in which the capitalizing financial institution issues a subordinated debt representing a value of a financial instrument on its capital account.

48. The method of claim 41, further comprising the step of:
using the capital on the capital account to leverage a loan.

49. The method of claim 41, further comprising the step of:
using the capital on the capital account to leverage an insurance policy.

50. A computer-readable medium containing instructions that cause a program, in a data processing system, to perform a method comprising the steps of:
accounting for at least a portion of the long-term value of the asset as capital on a capital account of a financial institution for a period of time; and
distributing an income to an owner of the asset during the period of time responsive to the accounting for the long-term value of the asset as capital on the capital account, wherein the owner of the asset maintains ownership of the asset during the period of time.

51. A data processing system comprising:
a memory comprising a program that accounts for at least a portion of a long-term value of an asset as capital on a capital account of a financial institution for a period of time, and distributes an income to an owner of the asset during the period of time responsive to the accounting for the long-term value of the asset as capital on the capital account, wherein the owner of the asset maintains ownership of the asset during the period of time; and
a processing unit that runs the program.

52. A data processing system comprising:
means for accounting for at least a portion of the long-term value of the asset as capital on a capital account of a financial institution for a period of time; and
means for distributing an income to an owner of the asset during the period of time responsive to the accounting for the long-term value of the asset as capital on the capital account, wherein the owner of the asset maintains ownership of the asset during the period of time.
